(19) United States
(12) Patent Application Publication
(10) Pub. No.: US 2014/0095997 A1
(43) Pub. Date: Apr. 3, 2014

(54) Audio System Optimization Interface

(71) Applicant: TESLA MOTORS, INC., Palo Alto, CA (US)

(72) Inventors: Miriam Vu, San Francisco, CA (US); Brennan Boblett, San Francisco, CA (US); Nalinichandra Penke, Fremont, CA (US); Kevin Hsieh, Redwood City, CA (US); Joe Nuxoll, San Jose, CA (US)

(73) Assignee: TESLA MOTORS, INC., Palo Alto, CA (US)

(21) Appl. No.: 13/671,830

(22) Filed: Nov. 8, 2012

Related U.S. Application Data
(63) Continuation of application No. 13/671,660, filed on Nov. 8, 2012.
(60) Provisional application No. 61/706,915, filed on Sep. 28, 2012.

(51) Int. Cl. G06F 3/0481

(52) U.S. Cl. CPC G06F 3/04817
USPC 715/716

(57) ABSTRACT

An audio system interface is provided, as well as a method of using same, in which a visual representation of the vehicle's passenger cabin is displayed on the vehicle's touch-screen. When a user's touch registers on the visual representation of the passenger compartment, the system matches the touch with one of a plurality of pre-defined acoustic sweet spots within the passenger compartment, and then adjusts the left-right speaker balance controller and the front-rear speaker fade controller to the specific left-right speaker balance setting and the specific front-rear speaker fader setting defined by the selected acoustic sweet spot.

### CROSS-REFERENCE TO RELATED APPLICATION

This application is a continuation of U.S. patent application Ser. No. 13/671,660, filed 8 Nov. 2012, the disclosure of which is incorporated herein by reference for any and all purposes. This application claims the benefit of the filing date of U.S. Provisional Patent Application Ser. No. 61/706,915, filed 28 Sep. 2012, the disclosure of which is incorporated herein by reference for any and all purposes.

### FIELD OF THE INVENTION

The present invention relates generally to a user interface and, more particularly, to a vehicle user interface that provides enhanced control of the perceived sound quality of the vehicle's audio system.

### BACKGROUND OF THE INVENTION

A conventional vehicle provides various interfaces that allow the user, i.e., the driver or passenger, a way of monitoring various vehicle conditions as well as controlling different vehicle functions. Depending upon the complexity of the systems to be monitored and/or controlled, such a user interface may utilize visual, tactile and/or audible feedback, and may be comprised of multiple interfaces, each interface grouping together those controls necessary to monitor and/or operate a specific vehicle subsystem (e.g., HVAC, entertainment/audio, navigation, etc.).

The audio system in a conventional vehicle includes a variety of controls, the number and type depending upon both the features offered in the particular system in question as well as the type of user interface implemented in the vehicle. At a minimum the audio system includes a volume control and a source selector that allows the source as well as a particular track or station to be designated. Common audio sources include AM radio, FM radio, HD Radio™, satellite radio, tape, CD, DVD audio, Bluetooth® coupled sources and USB coupled sources. More sophisticated audio systems also provide means for adjusting both the tonal qualities of the audio system and for balancing the output from the various speakers integrated throughout the passenger cabin. In a simple audio system the tonal qualities are adjusted in two frequency bands, i.e., treble and base. More sophisticated audio systems divide the audio spectrum into 3, 5, 7, 10 or more bands. Speaker balance controls are typically limited to left/right control, commonly referred to as balance control, and front/rear control, commonly referred to as fader control. Attempting to balance speaker output on a per-speaker basis is typically not an option available to the end user as such adjustment is exceedingly difficult without specialized acoustic characterization instruments, especially given that many car audio systems include as many as 15 or more speakers.

While there are countless ways of configuring a vehicle's audio system and its controls, generally the overarching goal of the audio system designer is to provide the end user with the best possible audio experience for a given price point and for a given level of audio system sophistication. A secondary, albeit extremely important goal, is to provide the user with a simple means of controlling the audio system, thereby enhancing user enjoyment and simultaneously minimizing the risks associated with controlling a relatively complex system while driving. The present audio system interface achieves both of these goals.

### SUMMARY OF THE INVENTION

An audio system interface for a vehicle is provided that utilizes a touch-screen mounted within a vehicle, where the touch-screen is configured to display at least one audio system graphical user interface (GUI) control screen that includes a visual representation of the vehicle's passenger compartment. The visual representation, which may be photorealistic, includes a plurality of seat representations that correspond to the actual vehicle seats. The system includes a memory in which a plurality of locations within the passenger cabin are stored, where each location corresponds to one of a plurality of acoustic sweet spots, and where each acoustic sweet spot defines a specific left-right speaker balance setting and a specific front-rear speaker fader setting. When a user's touch registers on the visual representation of the passenger compartment a system controller, which is coupled to the touch-screen, the audio system and the memory, is configured to match the touch with one of the acoustic sweet spots and then automatically adjust the left-right speaker balance controller and the front-rear speaker fade controller to the specific left-right speaker balance setting and the specific front-rear speaker fader setting defined by the selected acoustic sweet spot. If the user's touch does not coincide with one of the pre-defined acoustic sweet spots, the system controller may be configured to determine the closest pre-defined acoustic sweet spot to the touch, and then adjust the left-right speaker balance controller and the front-rear speaker fade controller to the specific left-right speaker balance setting and the specific front-rear speaker fader setting defined by the closest acoustic sweet spot. The GUI control screen may be configured to either display, or not display, acoustic sweet spot designators corresponding to the plurality of acoustic sweet spots. The plurality of acoustic sweet spots is preferably based on an acoustic pre-characterization of the vehicle passenger compartment.

The GUI control screen may also be configured to display (i) a touch sensitive balance slide controller comprised of a plurality of user selectable discrete touch sensitive regions and preferably positioned above or below the visual representation of the passenger cabin and (ii) a touch sensitive fade slide controller comprised of a second plurality of user selectable discrete touch sensitive regions and preferably positioned to the side of the visual representation of the passenger cabin. Each of the user selectable discrete touch sensitive regions of the balance slide controller, which may be selected using a tapping or a touch-and-drag motion, corresponds to one of a plurality of left-right speaker balance settings while each of the user selectable discrete touch sensitive regions of the fade slide controller, which may be selected using a tapping or a touch-and-drag motion, corresponds to one of a plurality of front-rear speaker fader settings. The currently selected left-right speaker balance setting may be highlighted on the balance slide controller and the currently selected front-rear speaker fader setting may be highlighted on the fade slide controller.

In another aspect of the invention, a method of selecting the audio balance of a vehicle's audio system is provided, the method including the steps of: (i) providing a touch-screen within the passenger compartment of the vehicle; (ii) displaying an audio system graphical user interface (GUI) control screen on the touch-screen; (iii) displaying a visual representation, which may be photorealistic, of the passenger compartment on the GUI control screen, where the visual representation includes a plurality of seat representations that correspond to the actual vehicle seats; (iv) accepting a user touch on the visual representation of the passenger compartment; (v) determining a specific location from a plurality of locations within the vehicle passenger compartment that corresponds to the user touch; (vi) matching the specific location to one of a plurality of acoustic sweet spots within the passenger cabin, where each acoustic sweet spot defines a specific left-right speaker balance setting from a plurality of left-right speaker balance settings and a specific front-rear speaker fader setting from a plurality of front-rear speaker fader settings; and (vii) automatically adjusting a left-right speaker balance controller to the specific left-right speaker balance setting and a front-rear speaker fade controller to the specific front-rear speaker fader setting defined by the acoustic sweet spot that matches the specific location. The method may include the step of displaying a plurality of acoustic sweet spot designators on the visual representation of the passenger compartment, where the plurality of acoustic sweet spot designators correspond to the plurality of acoustic sweet spots. The method may include the steps of determining the closest acoustic sweet spot designator to the user touch, determining a specific one of the plurality of acoustic sweet spots that corresponds to the closest acoustic sweet spot designator, and then automatically adjusting the left-right speaker balance controller to the specific left-right speaker balance setting defined by the closest acoustic sweet spot designator and automatically adjusting the front-rear speaker fade controller to the specific front-rear speaker fader setting defined by the acoustic sweet spot that matches the specific location defined by the closest acoustic sweet spot designator. The method may further include the step of acoustically characterizing the vehicle passenger compartment and determining a set of acoustic characterization data, including specific left-right speaker balance settings and specific front-rear speaker balance settings for each of the plurality of acoustic sweet spots.

The method may further comprise the steps of (i) displaying a touch sensitive balance slide controller above/below the visual representation of the passenger compartment on the GUI control screen, where the balance slide controller is comprised of a plurality of user selectable discrete touch sensitive regions that correspond to one of the plurality of left-right speaker balance settings, and (ii) displaying a touch sensitive fade slide controller to the side of the visual representation of the passenger compartment on the GUI control screen, where the fade slide controller is comprised of a second plurality of user selectable discrete touch sensitive regions that correspond to one of the plurality of front-rear speaker fader settings. Left-right speaker balance selections may be accepted via the plurality of user selectable discrete touch sensitive regions of the touch sensitive balance slide controller (for example, using touch or touch-and-drag motions). Front-rear speaker fader selections may be accepted via the second plurality of user selectable discrete touch sensitive regions of the touch sensitive fade slide controller (for example, using touch or touch-and-drag motions). The method may include the step of highlighting the left-right speaker balance selection on the balance slide controller and the step of highlighting the front-rear speaker fader selection on the fade slide controller.

A further understanding of the nature and advantages of the present invention may be realized by reference to the remaining portions of the specification and the drawings.

### BRIEF DESCRIPTION OF THE DRAWINGS

FIG. 1 provides a block diagram of an exemplary interface system that may be used with the present invention;

FIG. 2 provides a depiction of a vehicle's passenger cabin viewed from the top down, this figure including fade and balance slider controls;

FIG. 3 illustrates the same GUI control screen as shown in FIG. 2 after the user has made a minor adjustment of the balance slider, resulting in a minor change in the location of the acoustic sweet spot;

FIG. 4 illustrates a different method of selecting fade and balance control settings;

FIG. 5 illustrates a modified GUI control screen that may be used to select fade and balance control settings;

FIG. 6 illustrates an exemplary set of pre-defined sweet spots located throughout the passenger cabin;

FIG. 7 illustrates operation of the GUI control screen in which pre-defined sweet spots are used to simplify user fade/balance selections;

FIG. 8 illustrates a modified GUI control screen that may be used with the pre-defined sweet spots;

FIG. 9 illustrates the methodology used when the control system includes both pre-defined sweet spots and seat sensors; and

FIG. 10 illustrates the methodology used when the control system include pre-defined sweet spots, seat sensors, and the ability for the user to pre-configure the sweet spot selections.

### DESCRIPTION OF THE SPECIFIC EMBODIMENTS

The preferred embodiment of the present invention utilizes a large format touch-screen, both as a visual aid and as a means of controlling multiple vehicle subsystems, including the audio system. In at least one embodiment, the touch-screen is a 17-inch screen with a 16:10 aspect ratio. Due to its size as well as the limitations on available mounting space in a typical vehicle, preferably this touch-screen is mounted in portrait mode within the vehicle's central console. Besides being aesthetically pleasing, such a mounting location provides access to the data on the screen as well as the displayed system controls to both the driver and the passenger seated in the passenger front seat.

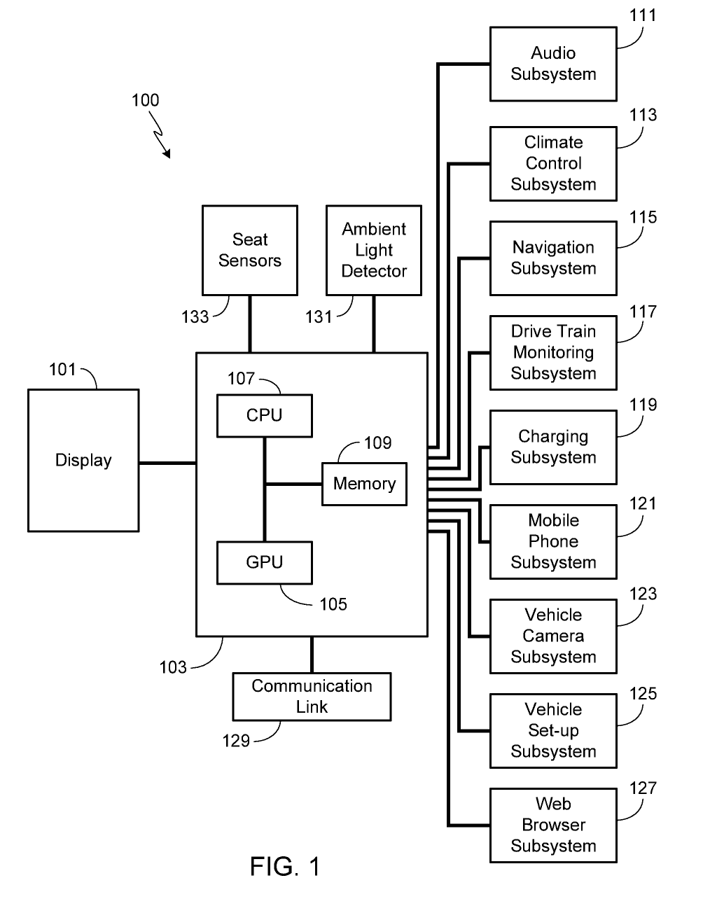

FIG. 1 provides a block diagram of an exemplary interface system 100 that includes touch-screen 101 and is suitable for use with the invention. In system 100, display 101 is coupled to a system controller 103. Controller 103 includes a graphical processing unit (GPU) 105, a central processing unit (CPU) 107, and memory 109. CPU 107 and GPU 105 may be separate or contained on a single chip set. Memory 109 may be comprised of flash memory, a solid state disk drive, a hard disk drive, or any other memory type or combination of memory types. Controller 103 is coupled to a variety of different vehicle subsystems, including the vehicle subsystem controls and vehicle subsystem monitors that are to be accessed and/or viewed on display 101. In addition to audio subsystem 111, preferably controller 103 is also coupled to other vehicle subsystems, for example climate control subsystem 113, navigation subsystem 115, drive train subsystem 117, charging subsystem 119, mobile phone subsystem 121, vehicle camera subsystem 123, vehicle set-up subsystem 125 and web browser subsystem 127. Vehicle set-up subsystem 125 allows general vehicle operating conditions to be set, conditions such as seat position, moon roof or sun roof position/operation, internal and external lighting, windshield wiper operation, etc. Preferably a mobile telecommunications link 129 is also coupled to controller 103, thereby allowing the controller to obtain updates, interface configuration profiles, and other data from an external data source (e.g., manufacturer, dealer, service center, web-based application, remote home-based system, etc.). Mobile telecommunications link 129 may be based on any of a variety of different standards including, but not limited to, GSM EDGE, UMTS, CDMA2000, DECT, and WiMAX.

In a preferred embodiment, interface system 100 allows the user to configure the audio system interface presented on touch-screen 101 in a variety of ways. Typically the user configures the display and controls using the display itself during the configuration process. Alternately, in at least one embodiment the user is able to configure the audio interface using a remote system, for example using a web-based interface application on a home computer, smart phone, tablet or other device, then downloading the configuration instructions to interface controller 103 via communication link 129.

When a particular user configures system 100, thereby personalizing a particular subsystem such as the audio interface to their particular preferences, preferably this set of configuration instructions is retained in memory 109. In a preferred implementation of the invention, system 100 is configured to accommodate multiple drivers/users, allowing each driver/user to record their preferences in memory 109. Preferably system 100 is configured to allow between two and four such configurations to be recorded in memory 109 thus, for example, allowing each driver in a family of four to record their own interface preferences. Then when one of the drivers with a pre-recorded set of interface preferences enters the vehicle, they simply select their previously recorded preferences. Selection of a pre-recorded set of interface preferences may be automatic, for example by utilizing means that identifies a particular driver. Various means that allow the identity of a user to be determined are known, including key fobs with embedded user identification information as well as more sophisticated image recognition systems. Alternately, system 100 may require that a particular user select their previously configured interface preferences, for example by pressing a hard button mounted within the vehicle, or pressing a soft button located on display 101.

In another aspect of the preferred embodiment of the invention, the light intensity or brightness of touch-screen 101 is configured to vary depending upon the ambient light intensity. It will be appreciated that the way in which the brightness varies depends upon the type of display technology employed (e.g., LED, OLED, AMOLED, LCD, etc.) and that the present invention is not limited to a specific type of display technology. The touch-screen light output may have only two levels, i.e., a daylight mode and a nighttime mode, or may vary over multiple steps, thus more accurately accounting for ambient light conditions (e.g., cloudy day versus sunny day). To determine ambient light conditions, controller 103 is preferably connected to an ambient light detector 131. Detector 131 may be mounted within the passenger compartment, for example on the dashboard, or mounted on an exterior location.

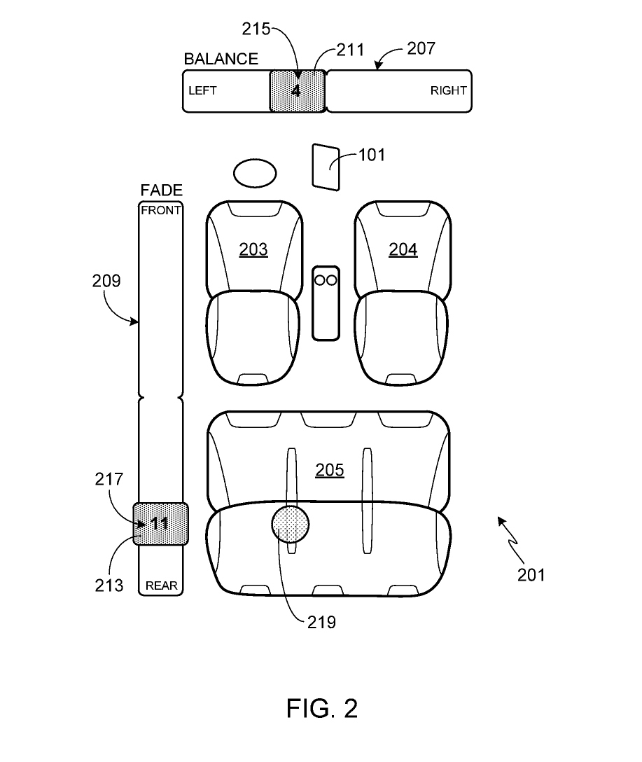

In accordance with the invention at least some, and preferably all, of the controls required to operate audio system 111 are accessed via touch-screen 101. Audio subsystem controls that are regularly required to utilize the audio system during normal operation of the vehicle, such as volume control and source/channel/track selection, are preferably accessed via touch-screen 101, although hard controls (e.g., buttons, rotating selector/level knobs, etc.) may be used for these controls. Those audio system controls that are required to optimize and personalize the sound qualities of the audio system, specifically the fade and balance controls, are accessed via touch-screen 101. The various audio system controls may be provided on a single menu screen displayed on touch-screen 101 or, as preferred, multiple menu screens may be used. In at least one such control screen, or a portion of one such control screen, a visual representation of the interior passenger compartment is provided that includes the balance and fade controls. This aspect of the invention is illustrated in FIGS. 2-8.

The top-down visual representation of passenger compartment 201 in FIGS. 2-8 is an accurate depiction of the passenger compartment in terms of the number of seats as well as the relative sizes and locations of these seats. Preferably the representation of the interior passenger compartment is photorealistic, i.e., a graphical representation that appears to be photographic. Providing the user with an accurate depiction of the passenger compartment helps the user to quickly and correctly identify the desired fade and balance settings. Note that while in the representation shown in FIGS. 2-8 there are two front seats 203/204 and a rear bench seat 205, the invention is clearly applicable to other passenger compartment configurations, e.g., 2 seats, 2+2 seating, three row configurations, etc.

In the fade/balance graphical user interface (GUI) control screen shown in FIG. 2, two slider controls are shown. The upper slider control 207 is used to adjust the left-right balance while vertical slider control 209 is used to adjust the front-rear balance of the audio system. The user adjusts balance controller 207 by touching soft button 211 and sliding it to the left or right (i.e., utilizing a touch-and-drag motion), thereby altering the output of the vehicle's speakers in order to achieve the desired sound distribution. Similarly the user adjusts fade controller 209 by touching soft button 213 and sliding it upwards or downwards (i.e., utilizing a touch-and-drag motion), thereby altering the front/rear speaker output distribution. In at least one configuration, the user may also tap a control bar (e.g., balance control bar 207 and/or fade control bar 209) at the desired location on the control bar, causing the soft button (e.g., soft buttons 211/213) to immediately move to that location. Preferably each soft button includes a numerical label that provides an indication of the relative location of that soft button on the slider control bar, e.g., soft button 211 includes a numerical label 215 (“4” in FIG. 2) and soft button 213 includes a numerical label 217 (“11” in FIG. 2). Note that as used herein, a soft button refers to a pre-defined, touch-sensitive region of touch-screen 101 that activates or otherwise controls a function in a manner similar to that of a hard button (i.e., a toggle switch, a push button, slider control, etc.). As soft buttons are well known in the art, further description will not be provided herein.

In order to obtain the benefits of the present invention, the acoustic properties of the passenger cabin of the vehicle utilizing the invention's fade and balance control system must be tested, analyzed and characterized. Note that since the shape of the passenger cabin, the location of the vehicle seats, and the materials used for the seats, flooring and door panels all affect the acoustic properties of the passenger cabin, preferably the acoustic characterization employed by a particular vehicle's audio system is based on the same model vehicle, as well as a passenger cabin utilizing the same configuration and materials.

During acoustic characterization the acoustic sweet spot, also referred to herein as simply the sweet spot, for each combination of the fade and balance controls is determined, the sweet spot being defined as the location within the cabin that, for a given setting of the fade/balance controls, offers the best balance of sound qualities, i.e., the optimum listening experience. While there is clearly an element of personal taste in determining the sweet spot, there are a variety of techniques and algorithms that may be used to determine the sweet spot based on a recognized set of sound qualities that most people find pleasing.

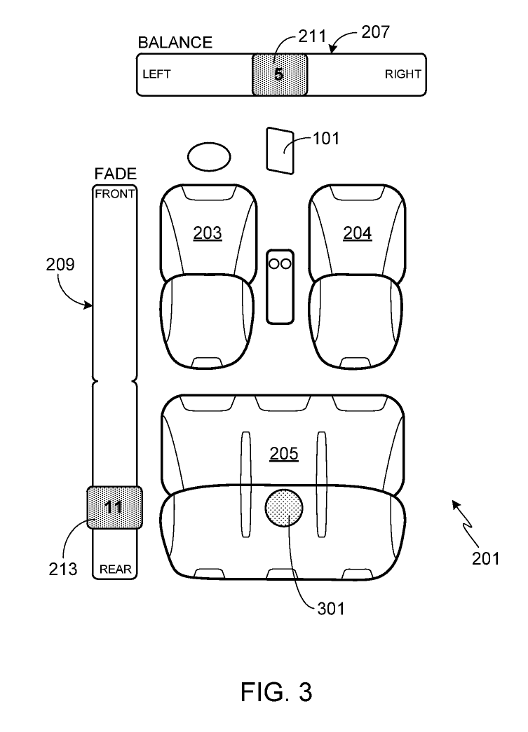

In accordance with one embodiment of the invention, as the user adjusts slider soft buttons 211 and 213, the sweet spot resulting from the user's selection is shown on the GUI control screen. Thus for example, for the fade and balance control settings shown in FIG. 2, system controller 103 identifies the calculated sweet spot and locates a sweet spot designator 219 at this location, the calculated sweet spot being based on the acoustic characterization data taken for that particular passenger cabin configuration which was previously stored in memory 109. In this embodiment the calculated sweet spot is shown on the GUI fade/balance control screen by a sweet spot symbol, i.e., sweet spot designator 219 in FIG. 2. As the user continues to make fade/balance adjustments, the sweet spot and its symbol are also adjusted in real time, thus giving the user immediate visual feedback regarding their selections. FIG. 3 shows the same GUI control screen after the user has made a minor adjustment of the balance control, moving slider soft button 211 to the right. As a result, the sweet spot has been repositioned to the right as shown (see sweet spot designator 301 in FIG. 3).

In the embodiment described above, as the user alters the balance and fade control settings using slider controls 207 and 209, respectively, the system calculates the corresponding acoustic sweet spot and places a sweet spot designator 219 on the touch-screen at the calculated sweet spot for these settings. In a minor modification of this embodiment, the user remotely configures the audio system, including the balance and fade settings, for example using a computer (e.g., home computer), smart phone application, or other remote device. These audio system configuration instructions are communicated to system controller 103 via communication link 129. Once these configuration instructions are received by system controller 103, the system calculates the corresponding sweet spot and appropriately locates the sweet spot designator on touch-screen 101, thus allowing the user to see the results of the fade/balance settings once seated in the vehicle.

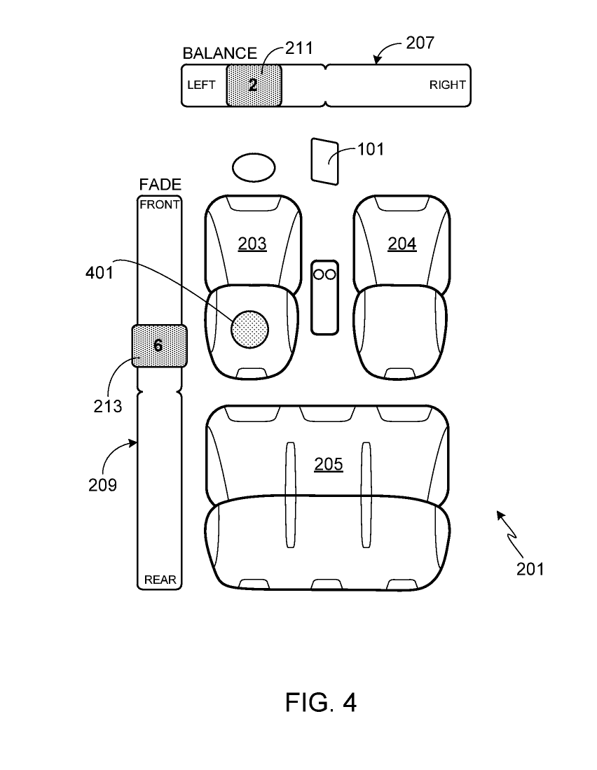

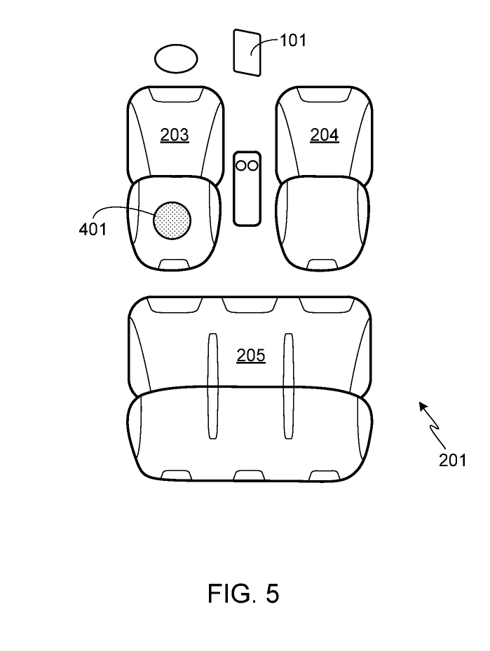

In another embodiment of the invention, the user is able to select fade and balance settings by selecting the desired sweet spot location on the depiction of the passenger cabin. In this embodiment when the user touches a location on the cabin depiction, system controller 103 automatically adjusts the fade and balance controls to achieve the desired sweet spot, the fade and balance settings based on the acoustic characterization data taken for that particular passenger cabin configuration and which was previously stored in memory 109. Thus, for example, when the user touches the GUI fade/balance control screen at a location 401 as shown in FIG. 4, the system automatically adjusts slider soft buttons 211 and 213 as shown. In a minor modification, the user may configure the audio system to only accept fade/balance settings by selecting the sweet spot. Preferably in this modified embodiment fade and balance slider controls 209 and 207 are eliminated from the GUI control screen. Accordingly in this embodiment when the user selects sweet spot 401, system controller 103 simply adjusts the fade and balance controls without indicating the adjustments on the GUI as illustrated in FIG. 5.

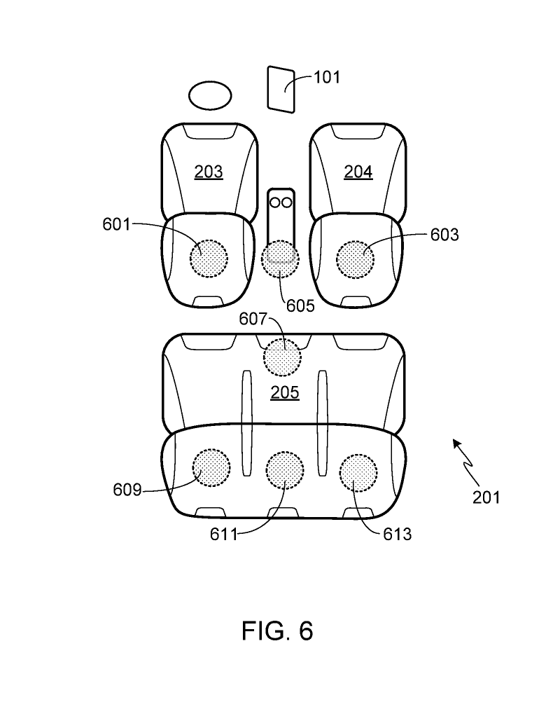

In another embodiment of the invention, the audio system is pre-configured with a preset number of sweet spots, the sweet spots based on the acoustic characterization data taken for that particular passenger cabin configuration and stored in memory. In this embodiment the preset sweet spots are placed at those locations that are commonly selected by users. The preset sweet spots may be displayed or not. FIG. 6 illustrates the GUI fade/balance control screen shown in FIG. 5 with an exemplary set of preset sweet spots shown in phantom. Sweet spot 601 corresponds to fade and balance settings optimized for the driver; sweet spot 603 corresponds to fade and balance settings optimized for the front seat passenger; sweet spot 605 corresponds to fade and balance settings that locates the sweet spot between the driver and the front seat passenger; sweet spot 607 corresponds to fade and balance settings that centrally locates the sweet spot in the passenger cabin, thus providing the best sound quality possible for all vehicle occupants; sweet spot 609 corresponds to fade and balance settings optimized for the left rear passenger; sweet spot 611 corresponds to fade and balance settings optimized for the center rear passenger; and sweet spot 613 corresponds to fade and balance settings optimized for the right rear passenger. It will be appreciated that the system may be configured with either a fewer number or a greater number of preset sweet spots. For example, a simplified configuration may only include three predefined sweet spots; one for the driver (i.e., sweet spot 601), one for the front portion of the cabin (i.e., sweet spot 605), and one for the entire cabin (i.e., sweet spot 607).

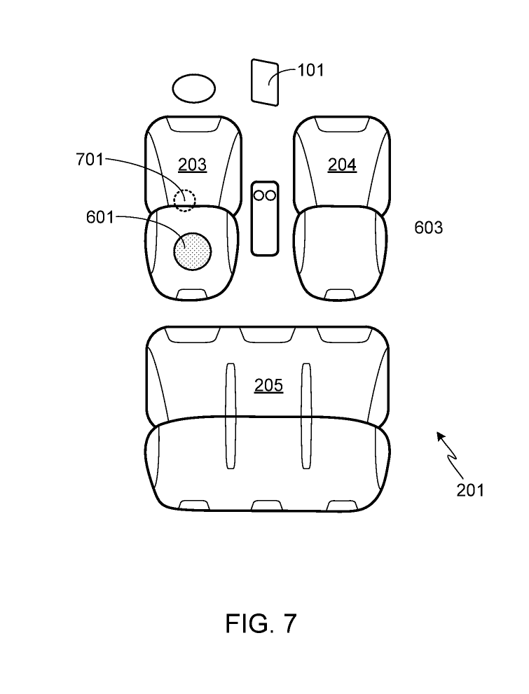

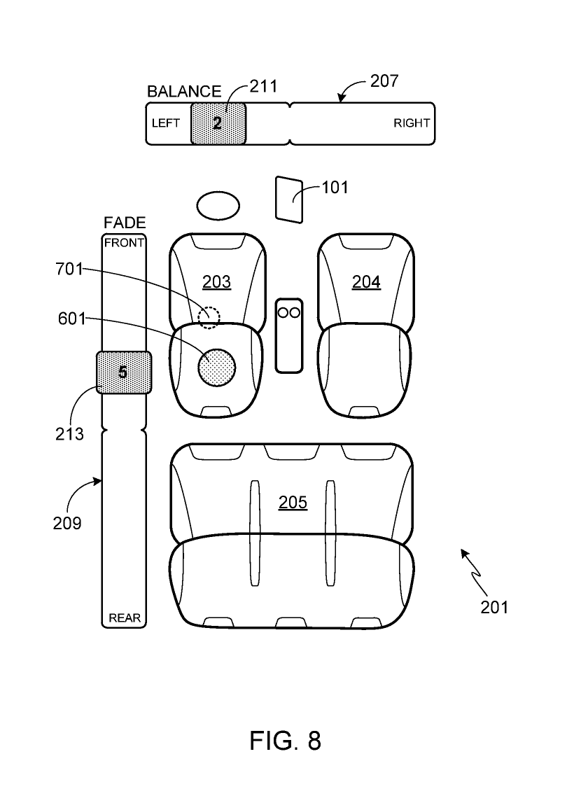

In one embodiment that utilizes a preset number of sweet spots located at pre-defined positions within the passenger cabin such as those shown in FIG. 6, the fade/balance GUI control screen does not show the preset sweet spots. In this configuration, and in a manner similar to that used with the embodiment illustrated in FIG. 4, the user simply touches the GUI control screen at the desired sweet spot location. However, unlike the embodiment illustrated in FIG. 4, in the current embodiment controller 103 adjusts the fade and balance controls for the closest pre-defined sweet spot, thus helping the user to achieve superior sound using a very simple adjustment process. For example if the user touches the screen at location 701 in FIG. 7, controller 103 sets the fade and balance controls to match the settings for sweet spot 601, i.e., the pre-defined sweet spot that is closest to location 701. Preferably the selected sweet spot is shown on the screen as in FIG. 7, although in a minor modification of this embodiment the selected sweet spot is not shown. It should be understood that fade slider control 209 and balance slider controller 207 may be shown with this embodiment, as illustrated in FIG. 8, thus providing the user with an additional means of optimizing the sound quality or making minor adjustments of the fade and balance settings once a sweet spot is selected as described above.

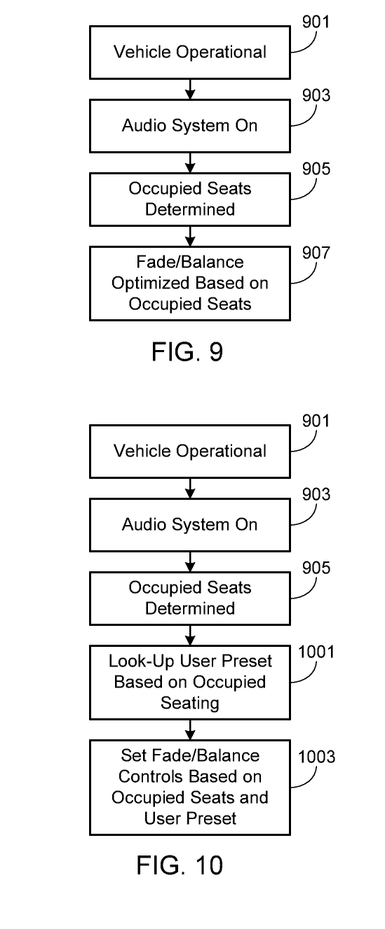

In another embodiment of the invention, seat sensors 133 (e.g., pressure sensors) are located in each of the vehicle's car seats. Each seat sensor 133 is coupled to system controller 103 and provides controller 103 with an indication as to whether the seat to which a particular sensor is attached is occupied. As illustrated in FIG. 9, whenever the vehicle is operating (step 901) and the audio system is on (step 903), system controller 103 determines which seats are occupied (step 905). Controller 103 then optimizes the fade and balance controls based on which seats are occupied and the acoustic characterization data taken for that particular passenger cabin configuration and stored in memory 109 (step 907). Stored in memory are preset sweet spots for each possible combination of occupied seats. Thus, for example, if only the driver's seat is occupied, system controller 103 can be configured to place the sweet spot at location 601. This embodiment may also include a GUI control screen that allows the user to modify the fade/balance settings as described above, for example selecting pre-set sweet spots via direct interaction with the visual representation of the passenger compartment (e.g., as illustrated in FIG. 7) and/or selecting fade/balance settings using a touch-sensitive slide controller (e.g., controllers 207/209 as illustrated in FIG. 2).

In the present embodiment, when controller 103 configures the fade/balance settings, the controller is relying on seat sensors 133 to determine which of the vehicle's seats are occupied and on the preset sweet spots stored in memory. Additionally, controller 103 uses a set of acoustic optimization configuration instructions stored in memory 109, these configuration instructions assigning the desired preset sweet spot for each combination of occupied seats. Typically the configuration instructions are stored in the system memory by the vehicle's manufacturer, although a third party (e.g., a service technician) may store these configuration instructions and/or alter previously stored configuration instructions. In a minor modification of this embodiment, the user sets these acoustic optimization configuration instructions, thereby defining the location for each sweet spot corresponding to each possible combination of occupied seats. As a result, after the controller determines which seats are occupied (step 905), the user-defined preset sweet spot is determined by the system controller based on a simple look-up table recorded in memory 109 based on the user's audio system configuration (step 1001). Controller 103 then sets the fade and balance controls based on which seats are occupied and the user's preset sweet spots (step 1003). Each user-defined sweet spot may be set by the user using balance and fade controllers 207 and 209, respectively. Alternately, the user may select the sweet spot for each set of occupied seats from a set of system pre-defined sweet spots, such as those shown in FIG. 6. By allowing the user to preset the sweet spot for each possible seating scenario, the user is able to personalize the settings. For example, if all of the seats are occupied, the system may determine that the optimum sweet spot is located at position 607. In contrast, for this same seating scenario the user may prefer to set the sweet spot at position 605, or some location between 605 and 607.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. An audio system interface for a vehicle, comprising:
an audio system comprised of a plurality of speakers, said plurality of speakers integrated within a vehicle passenger compartment of said vehicle;
a system controller coupled to said audio system;
a memory coupled to said system controller, wherein a plurality of locations within said vehicle passenger compartment are stored within said memory, wherein each of said plurality of locations corresponds to one of a plurality of acoustic sweet spots, and wherein each acoustic sweet spot of said plurality of acoustic sweet spots defines a specific left-right speaker balance setting from a plurality of left-right speaker balance settings and a specific front-rear speaker fader setting from a plurality of front-rear speaker fader settings; and
a touch-screen mounted within said vehicle passenger compartment and coupled to said system controller, said touch-screen configured to display at least one graphical user interface (GUI) control screen providing control over said audio system, wherein said GUI control screen displays a visual representation of said vehicle passenger compartment, wherein said visual representation includes a plurality of seat representations with each of said plurality of seat representations corresponding to an actual vehicle seat within said vehicle passenger compartment, and wherein whenever a touch registers on said visual representation of said vehicle passenger compartment displayed on said touch-screen said system controller is configured to match said touch with one of said plurality of acoustic sweet spots and automatically adjust a left-right speaker balance controller to said specific left-right speaker balance setting defined by said one of said plurality of acoustic sweet spots and automatically adjust a front-rear speaker fade controller to said specific front-rear speaker fader setting defined by said one of said plurality of acoustic sweet spots.

2. The audio system interface of claim 1, wherein said system controller is configured to determine a closest one of said plurality of acoustic sweet spots to said touch and automatically adjust said left-right speaker balance controller to said left-right speaker balance setting defined by said closest one of said plurality of acoustic sweet spots and automatically adjust said front-rear speaker fade controller to said front-rear speaker fader setting defined by said closest one of said plurality of acoustic sweet spots.

3. The audio system interface of claim 1, further comprising a plurality of acoustic sweet spot designators displayed on said visual representation of said vehicle passenger compartment on said GUI control screen, wherein said plurality of acoustic sweet spot designators correspond to said plurality of acoustic sweet spots.

4. The audio system interface of claim 3, wherein said system controller is configured to determine a closest one of said plurality of acoustic sweet spot designators to said touch and automatically adjust said left-right speaker balance controller to said left-right speaker balance setting defined by said closest one of said plurality of acoustic sweet spot designators and automatically adjust said front-rear speaker fade controller to said front-rear speaker fader setting defined by said closest one of said plurality of acoustic sweet spot designators.

5. The audio system interface of claim 1, wherein each acoustic sweet spot of said plurality of acoustic sweet spots is based on an acoustic pre-characterization of said vehicle passenger compartment.

6. The audio system interface of claim 1, further comprising:
a touch sensitive balance slide controller displayed on a first portion of said GUI control screen and positioned above or below said visual representation of said vehicle passenger compartment on said GUI control screen, said touch sensitive balance slide controller comprised of a first plurality of user selectable discrete touch sensitive regions, wherein each of said first plurality of user selectable discrete touch sensitive regions corresponds to one of said plurality of left-right speaker balance settings of said left-right speaker balance controller; and
a touch sensitive fade slide controller displayed on a second portion of said GUI control screen and positioned to one side of said visual representation of said vehicle passenger compartment on said GUI control screen, said touch sensitive fade slide controller comprised of a second plurality of user selectable discrete touch sensitive regions, wherein each of said second plurality of user selectable discrete touch sensitive regions corresponds to one of said plurality of front-rear speaker fader settings of said front-rear speaker fade controller.

7. The audio system interface of claim 6, wherein said specific left-right speaker balance setting is highlighted on said touch sensitive balance slide controller, and wherein said specific front-rear speaker fader setting is highlighted on said touch sensitive fade slide controller.

8. The audio system interface of claim 6, wherein each of said first plurality of user selectable discrete touch sensitive regions corresponding to said plurality of left-right speaker balance settings is selectable by tapping, and wherein each of said second plurality of user selectable discrete touch sensitive regions corresponding to said plurality of front-rear speaker fader settings is selectable by tapping.

9. The audio system interface of claim 6, wherein each of said first plurality of user selectable discrete touch sensitive regions corresponding to said plurality of left-right speaker balance settings is selectable via a touch-and-drag motion on said touch sensitive balance slide controller, and wherein each of said second plurality of user selectable discrete touch sensitive regions corresponding to said plurality of front-rear speaker fader settings is selectable via a touch-and-drag motion on said touch sensitive fade slide controller.

10. The audio system interface of claim 1, wherein said visual representation of said vehicle passenger compartment is photorealistic.

11. A method of selecting audio balance, the method comprising the steps of:
providing a touch-screen within a vehicle passenger compartment of a vehicle;
displaying a graphical user interface (GUI) control screen on said touch-screen, said GUI control screen providing control over an audio system integrated within said vehicle;
displaying a visual representation of said vehicle passenger compartment on said GUI control screen, wherein said visual representation includes a plurality of seat representations with each of said plurality of seat representations corresponding to an actual vehicle seat within said vehicle passenger compartment;
accepting a user touch on said visual representation of said vehicle passenger compartment displayed on said GUI control screen;
determining a specific location from a plurality of locations within said vehicle passenger compartment that corresponds to said user touch on said visual representation of said vehicle passenger compartment;
matching said specific location to one of a plurality of acoustic sweet spots within said vehicle passenger compartment, wherein each acoustic sweet spot of said plurality of acoustic sweet spots defines a specific left-right speaker balance setting from a plurality of left-right speaker balance settings and a specific front-rear speaker fader setting from a plurality of front-rear speaker fader settings;
automatically adjusting a left-right speaker balance controller to said specific left-right speaker balance setting defined by said one of said plurality of acoustic sweet spots; and
automatically adjusting a front-rear speaker fade controller to said specific front-rear speaker fader setting defined by said one of said plurality of acoustic sweet spots.

12. The method of claim 11, wherein if said specific location does not exactly match one of said plurality of acoustic sweet spots, said matching step further comprises the step of determining a closest one of said plurality of acoustic sweet spots to said specific location, wherein said step of automatically adjusting said left-right speaker balance controller further comprises the step of automatically adjusting said left-right speaker balance controller to said specific left-right speaker balance setting defined by said closest one of said plurality of acoustic sweet spots, and wherein said step of automatically adjusting said front-rear speaker fade controller further comprises the step of automatically adjusting said front-rear speaker fade controller to said specific front-rear speaker fader setting defined by said closest one of said plurality of acoustic sweet spots.

13. The method of claim 11, further comprising the step of displaying a plurality of acoustic sweet spot designators on said visual representation of said vehicle passenger compartment on said GUI control screen, wherein said plurality of acoustic sweet spot designators correspond to said plurality of acoustic sweet spots.

14. The method of claim 13, further comprising the steps of determining a closest one of said plurality of acoustic sweet spot designators to said user touch, determining a specific one of said plurality of acoustic sweet spots that corresponds to said closest one of said plurality of acoustic sweet spot designators, automatically adjusting said left-right speaker balance controller to said left-right speaker balance setting defined by said specific one of said plurality of acoustic sweet spots corresponding to said closest one of said plurality of acoustic sweet spot designators, and automatically adjusting said front-rear speaker fade controller to said front-rear speaker fader setting defined by said specific one of said plurality of acoustic sweet spots corresponding to said closest one of said plurality of acoustic sweet spot designators.

15. The method of claim 11, further comprising the steps of acoustically characterizing said vehicle passenger compartment, determining a set of acoustic characterization data for said vehicle passenger compartment, and determining said specific left-right speaker balance setting and said specific front-rear speaker balance setting for each of said plurality of acoustic sweet spots from said set of acoustic characterization data.

16. The method of claim 11, further comprising the steps of:
displaying a touch sensitive balance slide controller on a first portion of said GUI control screen and positioned above or below said visual representation of said vehicle passenger compartment on said GUI control screen, said touch sensitive balance slide controller comprised of a first plurality of user selectable discrete touch sensitive regions, wherein each of said first plurality of user selectable discrete touch sensitive regions corresponds to one of said plurality of left-right speaker balance settings of said left-right speaker balance controller; and
displaying a touch sensitive fade slide controller on a second portion of said GUI control screen and positioned to one side of said visual representation of said vehicle passenger compartment on said GUI control screen, said touch sensitive fade slide controller comprised of a second plurality of user selectable discrete touch sensitive regions, wherein each of said second plurality of user selectable discrete touch sensitive regions corresponds to one of said plurality of front-rear speaker fader settings of said front-rear speaker fade controller.

17. The method of claim 16, further comprising the steps of highlighting said specific left-right speaker balance setting on said touch sensitive balance slide controller, and highlighting said specific front-rear speaker fader setting on said touch sensitive fade slide controller.

18. The method of claim 16, further comprising the steps of adjusting said specific left-right speaker balance setting in response to a touch of one of said first plurality of user selectable discrete touch sensitive regions corresponding to said plurality of left-right speaker balance settings, and adjusting said specific front-rear speaker fader setting in response to a touch of one of said second plurality of user selectable discrete touch sensitive regions corresponding to said plurality of front-rear speaker fader settings.

19. The method of claim 16, further comprising the steps of adjusting said specific left-right speaker balance setting in response to a touch-and-drag motion of one of said first plurality of user selectable discrete touch sensitive regions corresponding to said plurality of left-right speaker balance settings, and adjusting said specific front-rear speaker fader setting in response to a touch-and-drag motion of one of said second plurality of user selectable discrete touch sensitive regions corresponding to said plurality of front-rear speaker fader settings.

20. The method of claim 11, wherein said step of displaying said visual representation of said vehicle passenger compartment on said GUI control screen further comprises the step of displaying a photorealistic representation of said vehicle passenger compartment on said GUI control screen.
